(19) United States
(12) Patent Application Publication
(10) Pub. No.: US 2026/0225538 A1
(43) Pub. Date: Aug. 6, 2026

(54) MOUNTING SYSTEM FOR DEVICES OR OBJECTS IN A VEHICLE AND METHODS OF MAKING AND USING

(71) Applicant: National Products, Inc., Seattle, WA (US)

(72) Inventors: Jeffrey D. Carnevali, Seattle, WA (US); Stefan Michael Gottschalk, Seattle, WA (US)

(21) Appl. No.: 19/649,344

(22) Filed: Apr. 16, 2026

Related U.S. Application Data
(63) Continuation-in-part of application No. 19/043,280, filed on Jan. 31, 2025.

(51) Int. Cl. B60R 11/02; B60R 11/00

(52) U.S. Cl. CPC B60R 11/0252; B60R 2011/0005; B60R 2011/0052; B60R 2011/0071

(57) ABSTRACT

A mounting system for mounting devices or objects within a vehicle includes a rail having a first end and a second end for coupling to a floor of the vehicle, a dashboard, or a console attached to, or mountable in, the vehicle, the rail includes a first section extending upward from the first end, a second section extending upward from the second end, and a horizontal section intermediate between the first section and the second section. One or more mounts can be attached to the rail. The mounting system also includes a first attachment arrangement for attachment of the first end of the rail to the floor, dashboard, or console; a second attachment arrangement for attachment of the second end of the rail to the floor, dashboard, or console; and, optionally, an intermediate attachment arrangement for coupling the horizontal section to a dashboard, console, or engine cover.

### CROSS-REFERENCE TO RELATED APPLICATIONS

This patent application is a continuation-in-part of U.S. patent application Ser. No. 19/043,280, filed Jan. 31, 2025, which is incorporated herein by reference in its entirety.

### FIELD

The present invention is directed to mounting systems for devices or objects in a vehicle. The present invention is also directed to mounting systems for devices or objects in a vehicle that are attached to the floor, dashboard, other portion of the vehicle, or to a console that is part of the vehicle or mountable in the vehicle.

### BACKGROUND

Mobile devices, such as smartphones, cellular or mobile phones, tablets, personal data assistants, and other portable devices, are now ubiquitous. Mounts and cradles can be used to protect the mobile device, to mount the mobile device onto a surface or object, or to provide power, or data to or from, the mobile device, or any combination thereof. It is often desirable to mount a mobile device or other objects within a vehicle. There is a need for a system for mounting devices and objects in a vehicle.

### BRIEF SUMMARY

One embodiment is a mounting system for mounting devices or objects within a vehicle that includes a rail having a first end configured for coupling to a console attached to, or mountable in, the vehicle and a second end, opposite the first end, configured for coupling to a floor of the vehicle or the console, the rail including a first section extending upward from the first end away from the console when the rail is coupled to the console, a second section extending upward from the second end away from the floor or the console when the rail is coupled to the floor or the console, and a horizontal section intermediate between the first section to the second section and having a horizontal length of at least 0.07 meters, wherein the rail is configured for attachment of one or more mounts to the rail at multiple positions along the rail; a first attachment arrangement configured for attachment to the first end of the rail and for attachment to the floor or the console; and a second attachment arrangement physically separate from the first attachment arrangement and configured for attachment to the second end of the rail and for attachment to the floor or the console.

In at least some embodiments, the second end is configured for coupling to the console and the second attachment arrangement is configured for attachment to the console. In at least some embodiments, the mounting system further includes a first intermediate attachment arrangement configured for coupling the horizontal section of the rail to a dashboard, another console, or an engine cover of the vehicle. In at least some embodiments, the mounting system further includes a second intermediate attachment arrangement configured for coupling the rail to the dashboard, the other console, or the engine cover of the vehicle.

In at least some embodiments, the mounting system further includes the console, wherein the console is mountable in the vehicle. In at least some embodiments, the mounting system further includes a mount attached or attachable to the rail. In at least some embodiments, the mount is configured for coupling to a device or object. In at least some embodiments, the mount is configured for at least one of rotating, tilting, pivoting, or swiveling the coupled device or object.

Another embodiment is a mounting system for mounting devices or objects within a vehicle that includes a rail having a first end configured for coupling to a floor of a vehicle and a second end opposite the first end, the rail including a first section extending upward from the first end away from the floor when the rail is coupled to the floor and a horizontal section intermediate between the first section and the second end, the horizontal section having a horizontal length of at least 0.07 meters, wherein the rail is configured for attachment of one or more mounts to the rail at multiple positions along the rail; a first attachment arrangement configured for attachment to the first end of the rail and for attachment to the floor; and a second attachment arrangement physically separate from the first attachment arrangement and configured for attachment of the horizontal section to a dashboard of the vehicle.

In at least some embodiments, the mounting system further includes a third attachment arrangement configured for attachment to the second end of the rail and for attachment to the floor. In at least some embodiments, the mounting system further includes a fourth attachment arrangement configured for attachment to the rail and for attachment to the dashboard. In at least some embodiments, the first attachment arrangement is configured for coupling to the floor of the vehicle via a floor track using a fastener of the floor track. In at least some embodiments, the first attachment arrangement is configured for coupling to the floor of the vehicle via a seat bolt.

Yet another embodiment is a mounting system for mounting devices or objects within a vehicle that includes a rail having at least one vertical section extending vertically relative to the vehicle when the mounting system is mounted in the vehicle and at least one horizontal section extending horizontally relative to the vehicle when the mounting system is mounted in the vehicle, the at least one horizontal section including a first horizontal section having a horizontal length of at least 0.07 meters, wherein the rail is configured for attachment of one or more mounts to the rail at multiple positions along the rail; a first attachment arrangement configured for attachment to a one of the at least one vertical section and for attachment to a dashboard of the vehicle or a console attached to, or mountable in, the vehicle; and a second attachment arrangement physically separate from the first attachment arrangement and configured for attachment to the first horizontal section and for attachment to the dashboard of the vehicle.

In at least some embodiments, the first attachment arrangement is configured for attachment to the console. In at least some embodiments, the mounting system further includes a third attachment arrangement configured for attachment to the rail and for attachment to the dashboard. In at least some embodiments, the at least one vertical section includes a first vertical section and a second vertical section that is separated from the first vertical section by at least one of the at least one horizontal section, wherein the first attachment arrangement is configured for attachment to the first vertical section and the third attachment arrangement is configured for attachment to the third vertical section. In at least some embodiments, the rail forms a loop. In at least some embodiments, the horizontal section has a horizontal length of at least 0.1 meters.

A further embodiment is a method for using any of the mounting systems described herein, the method includes providing the mounting system in the vehicle and attaching a mount to the rail of the mounting system.

One embodiment is a mounting system for mounting devices or objects within a vehicle. The mounting system includes a rail having a first end configured for coupling to a floor of the vehicle or to a console attached to, or mountable in, the vehicle and a second end, opposite the first end, configured for coupling to the floor of the vehicle or the console, the rail including a first section extending upward from the first end away from the floor or the console when the rail is coupled to the floor or console, a second section extending upward from the second end away from the floor or the console when the rail is coupled to the floor or console, and a horizontal section intermediate between the first section to the second section and having a horizontal length of at least 0.07 meters, wherein the rail is configured for attachment of one or more mounts to the rail at multiple positions along the rail; a first attachment arrangement configured for attachment to the first end of the rail and for attachment to the floor or the console; and a second attachment arrangement physically separate from the first attachment arrangement and configured for attachment to the second end of the rail and for attachment to the floor or the console.

In at least some embodiments, the mounting system further includes an intermediate attachment arrangement configured for coupling the horizontal section of the rail to a dashboard, another console, or an engine cover of the vehicle. In at least some embodiments, the mounting system further includes the console, wherein the console is mountable in the vehicle.

In at least some embodiments, the horizontal section has a horizontal length of at least 0.1 meters. In at least some embodiments, the rail includes at least one additional upward-extending section. In at least some embodiments, the rail includes at least one additional horizontal section. In at least some embodiments, the rail includes at least six bends.

In at least some embodiments, the rail includes tubing. In at least some embodiments, the rail is made of a plastic material. In at least some embodiments, the rail is made of metal. In at least some embodiments, each of the first attachment arrangement and the second attachment arrangement includes a bracket. In at least some embodiments, at least one of the first attachment arrangement or the second attachment arrangement is configured for coupling to the floor of the vehicle via a floor track of the vehicle using a fastener of the floor track. In at least some embodiments, at least one of the first attachment arrangement or the second attachment arrangement is configured for coupling to the floor of the vehicle via a seat bolt. In at least some embodiments, one of the first attachment arrangement or the second attachment arrangement is configured for coupling to the floor of the vehicle and another one of the first attachment arrangement or the second attachment arrangement is configured for coupling to the console.

In at least some embodiments, the mounting system further includes a mount attached or attachable to the rail. In at least some embodiments, the mount is configured for coupling to a device or object. In at least some embodiments, the mount is configured for at least one of rotating, tilting, pivoting, or swiveling the coupled device or object.

Another embodiment is a method for using any of the mounting systems described above. The method includes providing the mounting system in the vehicle; and attaching a mount to the rail of the mounting system.

In at least some embodiments, the method further includes attaching a device or object to the mount. In at least some embodiments, the method further includes pivoting, rotating, tilting, or swiveling the device or object attached to the mount.

In at least some embodiments, providing the mounting system includes attaching the first attachment arrangement, the second attachment arrangement, and, when used, the intermediate attachment arrangement to the vehicle. In at least some embodiments, providing the mounting system includes attaching at least one of the first attachment arrangement or the second attachment arrangement to the console.

In at least some embodiments, the attaching includes attaching each of the first attachment arrangement and the second attachment arrangement to a different floor track or seat bolt of the vehicle using a fastener of the floor track. In at least some embodiments, the attaching including attaching the intermediate attachment arrangement to the rail and to a dashboard, console, or engine cover of the vehicle.

In at least some embodiments, providing the mounting system includes attaching the first attachment arrangement and the second attachment arrangement to the console, wherein the console is part of the vehicle. In at least some embodiments, the mounting system includes the console and providing the mounting system includes mounting the console in the vehicle. In at least some embodiments, the mounting system includes the console, which may or may not be part of the vehicle, and providing the mounting system includes mounting the console in the vehicle. In at least some embodiments, providing the mounting system includes attaching at least one of the first attachment arrangement or the second attachment arrangement to the floor.

Yet another embodiment is a method for making any of the mounting arrangement the mounting systems describe above. The method includes providing tubing; and bending the tubing to form the rail with a plurality of bends. In at least some embodiments, the method further includes scanning the vehicle or another vehicle of a same type with a three-dimensional scanner to obtain a shape of components within the vehicle, wherein the bending includes bending the tubing using the scan of the vehicle to produce a shape of the rail.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic perspective side view of one embodiment of a mounting system for a mounting devices or objects in a vehicle, according to the invention;

FIG. 2 is a schematic perspective side view of the mounting system of FIG. 1 with attached devices and objects, according to the invention;

FIG. 3 is a schematic perspective side view of the mounting system of FIG. 1 with attached devices and objects after swiveling or rotation, according to the invention;

FIG. 4 is a schematic perspective side view of the mounting system of FIG. 1 installed in a vehicle, according to the invention;

FIG. 5A is a schematic perspective side view of a portion of the mounting system of FIG. 1A for attachment to the floor of the vehicle, according to the invention;

FIG. 5B is a schematic perspective side view of a portion of the mounting system of FIG. 1A attached, according to one embodiment, to the floor of the vehicle, according to the invention;

FIG. 6A is a schematic perspective side view of a portion of the mounting system of FIG. 1A for attachment to the dashboard (or console or engine cover) of the vehicle, according to the invention;

FIG. 6B is a schematic perspective side view of a portion of the mounting system of FIG. 1A attached, according to one embodiment, to the dashboard (or console or engine cover) of the vehicle, according to the invention;

FIG. 7A is a schematic perspective side view of another embodiment of a mounting system for a mounting devices or objects in a vehicle with the mounting system attached to a console, according to the invention;

FIG. 7B is a schematic perspective side view of the mounting system of FIG. 7A with attached devices and objects, according to the invention;

FIG. 7C is a schematic perspective side view of an intermediate attachment arrangement and portion of the rail of the mounting system of FIG. 7A, according to the invention;

FIG. 8 is a schematic perspective view of a portion of a vehicle and a third embodiment of the mounting system, according to the invention;

FIG. 9 is a schematic perspective view of a portion of a vehicle and a fourth embodiment of the mounting system, according to the invention;

FIG. 10 is a schematic perspective view of a portion of a vehicle and a fifth embodiment of the mounting system, according to the invention;

FIG. 11 is a schematic perspective view of a portion of a vehicle and a sixth embodiment of the mounting system, according to the invention;

FIG. 12 is a schematic perspective view of a portion of a vehicle and a seventh embodiment of the mounting system, according to the invention;

FIG. 13 is a schematic perspective view of a portion of a vehicle and an eighth embodiment of the mounting system, according to the invention;

FIG. 14 is a schematic perspective view of a portion of a vehicle and a ninth embodiment of the mounting system, according to the invention; and

FIG. 15 is a schematic perspective view of a portion of a vehicle and a tenth embodiment of the mounting system, according to the invention.

### DETAILED DESCRIPTION

The present invention is directed to mounting systems for devices or objects in a vehicle. The present invention is also directed to mounting systems for devices or objects in a vehicle that are attached to the floor, dashboard, other portion of the vehicle, or to a console that is part of the vehicle or mountable in the vehicle.

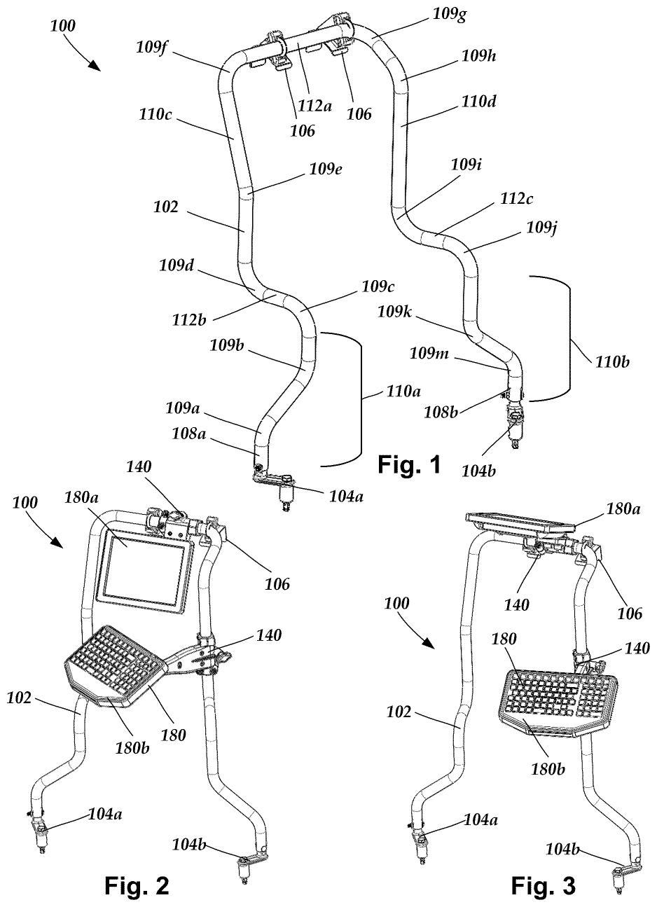

FIGS. 1 to 4 illustrate one embodiment of a mounting system 100 for mounting devices (e.g., mobile devices) or other objects 180 within a vehicle 150. Non-limiting examples of devices or objects 180 that may be mountable on the mounting system 100 can include, but are not limited to, laptop computers, tablets, mobile phones, keyboards, charging or data transfer docks or cradles for electronic devices, monitors, mouse trays, printers, cameras, point-of-sale devices, global positioning system (GPS) devices, radios, weapon holders, mirrors, lights, beverage cup holders, antennas, light bar controls, siren controls, or any other suitable device (e.g., suitable electronic devices) or object. Non-limiting examples of docks or cradles are described in U.S. Pat. Nos. 9,831,904; 11,029,731; 11,076,032; 11,277,506; 11,289,864; 11,489,350; and 12,126,199; U.S. Patent Application Publication No. 2024/0361803; and U.S. patent applications Ser. Nos. 18/590,837 and 18/621,977, all of which are incorporated herein by reference in their entireties. In at least some embodiments, the mounting system can facilitate the mounting of multiple devices and objects. In at least some embodiments, the mounting system can be readily attached within the vehicle without substantial vehicle modification. In at least some embodiments, the mounting system can provide ample mounting space while limiting interference with existing vehicle structures and controls.

The mounting system 100 includes a rail 102, a first attachment arrangement 104a, a second attachment arrangement 104b, and at least one intermediate attachment arrangement 106. In at least some embodiments, the mounting system does not include the at least one intermediate attachment arrangement 106. The rail 102 is arranged for the attachment of one or more mounts 140 to the rail for mounting the device(s) or object(s) 180 to the rail. In at least some embodiments, the rail 102, or a part of the rail 102, is formed using tubing or other hollow, elongate object, although elongate solid (e.g., non-hollow) objects can also be used for the rail or portions of the rail. The rail 102 can be made from any suitable material including, but not limited to, plastic material (for example, polyvinyl chloride (PVC), nylon, polyethylene, polypropylene, or polyurethane or the like or any combination thereof), fiberglass, metal (for example, aluminum, copper, stainless steel, or steel, or the like or any combination thereof), or the like or any combination thereof. The rail 102, or a part of the rail 102, can have a circular, oval, rectangular, square, triangular, octagonal, hexagonal, or any other suitable cross-sectional shape. The rail 102 can have any suitable outer diameter or cross-sectional width(s) and can have any suitable tubing thickness. The materials, cross-sectional shape, outer diameter, cross-sectional width, tubing thickness, or other structural features of the rail 102 can be uniform along the entire rail or can differ along the rail.

The rail 102 has multiple bends, such as bends 109a, 109b, 109c, 109d, 109e, 109f, 109g, 109h, 109i, 109j, 109k, 109m of the rail 102 illustrated in FIG. 1. In at least some embodiments, the rail can be shaped using a CNC (computer numerical control) tube bender or the like or any other suitable machinery or method. The rail 102 can be formed as a single part or formed as multiple parts that are joined together using adhesive, fasteners, or any other suitable joining element(s) or method. For example, the rail 102 can be formed using a single tube or multiple tube sections that are joined together.

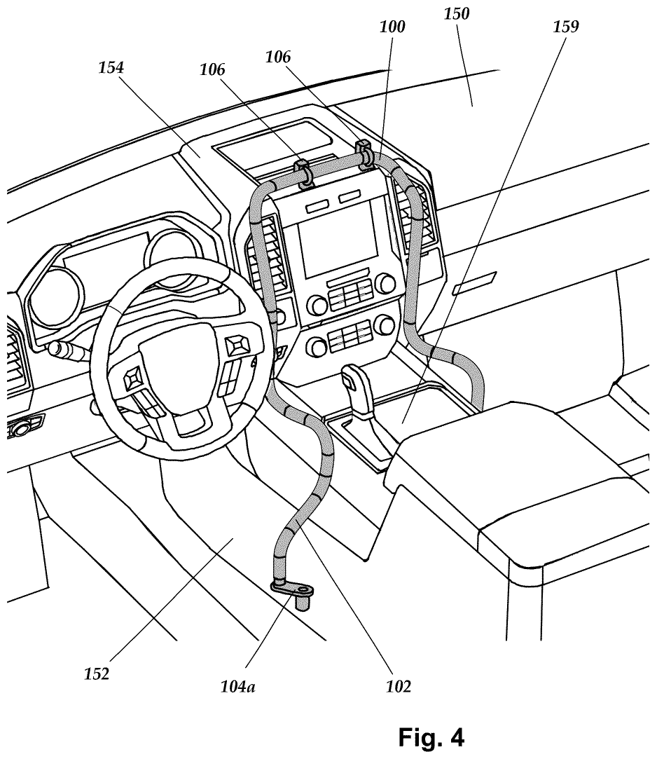

In at least some embodiments, the overall shape, including the bends and straight sections, of the rail 102 is designed in view of the contours of the vehicle, for example, the contours of one or more of the dashboard, console, engine cover, or the like or any combination thereof, as illustrated, for example, in FIG. 4. In at least some embodiments, the surfaces of the vehicle (for example, the dashboard, console, floor, engine cover, or other portions of the vehicle (or any combination thereof) near the site for placement of the rail 102) can be scanned in three dimensions and the rail 102 can be designed to fit the scanned contours, surfaces, or shapes of the vehicle or its components. For example, the shape of the rail 102 can be designed using a software program or application (e.g., a computer-aided design (cad) program or application) manually, automatically by a computer, or any combination thereof and the resulting geometry of the rail can be delivered to a machine (e.g., a CNC tube bender) to form tubing or other materials into the rail. In at least some embodiments, the rail 102 can be custom designed for a particular vehicle. In at least some embodiments, a rail 102 can be designed for a particular make or model of a vehicle or for a range of makes or models.

In at least some embodiments, the rail 102 includes first and second sections 110a, 110b extending upward (for example, extending vertically, non-horizontally, or at an angle, relative to the floor of the vehicle where the rail is attached, in a range of 30 to 90 degrees) from the first and second ends 108a, 108b, respectively, of the rail when the rail is coupled to the floor 152 of the vehicle 150. In at least some embodiments, a section “extends upward” or is “upward-extending” when portions of the section further from the end of the rail 102 closest to that section are also further in distance from the floor of the vehicle when the rail 102 is attached to the floor of the vehicle. (In at least some embodiments, one or both of the first or second ends 108a, 108b may include a horizontal (e.g., lateral) portion from which the first or second section 110a, 110b, respectively, extends.) In at least some embodiments, the rail 102 includes one or more additional upward-extending sections (e.g., sections 110c, 110d, as illustrated in FIG. 1). In at least some embodiments, one or more of the first section 110a, second section 110 b, or any additional upward-extending section can include one or more bends. As an example, the first section 110a of the embodiment of the rail 102 illustrated in FIG. 1 includes bends 109a, 109b.

The rail 102 also includes a horizontal section 112a, which, in at least some embodiments, facilitates coupling the rail to a dashboard 154, console, engine cover, or other portion of the vehicle 150. The horizontal section 112a is intermediate between the first section 110a and the second section 110b. In at least some embodiments, the horizontal section 112a has a length of at least 0.07, 0.1, 0.15, or 0.2 meters. The rail 102 can include one or more additional horizontal sections (e.g., sections 112b, 112c in FIG. 1). In at least some embodiments, the rail 102 can include one or more sections that are not solely vertical or horizontal.

In at least some embodiments, the rail 102 is configured to be attached or anchored to the floor 152, or other suitable portion, of the vehicle 150. In at least some embodiments, the rail 102 includes a first end 108a and a second end 108b each coupleable, or coupled, to the floor 152 of the vehicle 150 using the first attachment arrangement 104a and second attachment arrangement 104b, respectively. In at least some embodiments, the rail 102 is also coupled to the dashboard 154, console, or engine cover (or other portion) of the vehicle 150 intermediate the first and second ends 108a, 108b using at least one intermediate attachment arrangement 106.

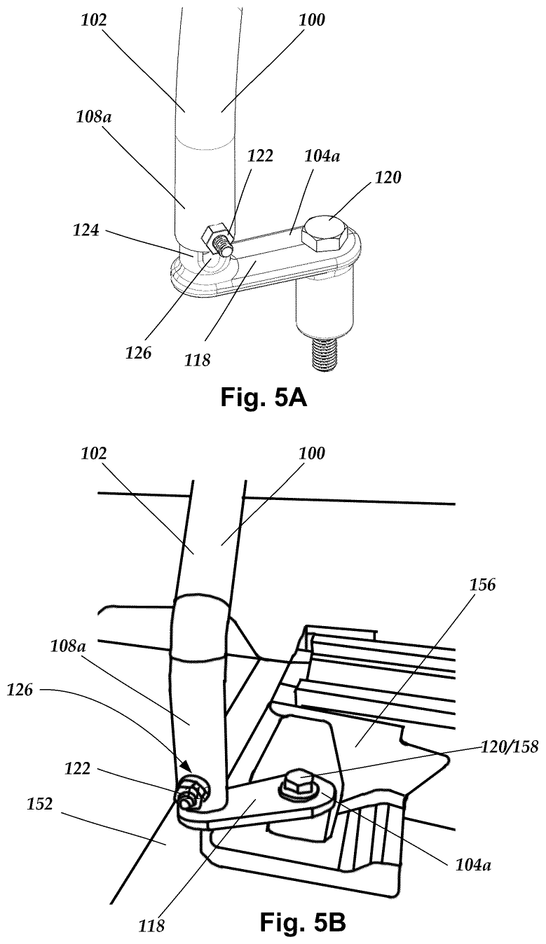

In at least some embodiments, the first attachment arrangement 104a couples the first end 108a of the rail 102 to the floor 152 of the vehicle 150 and the second attachment arrangement 104b couples the second end 108b of the rail to the floor of the vehicle. FIGS. 5A and 5B illustrate one embodiment of the first attachment arrangement 104a couples the first end 108a of the rail 102 to the floor 152 of the vehicle. In at least some embodiments, the first attachment arrangement 104a, the second attachment arrangement 104b, or both include at least one bracket 118 for attachment to the floor 152 of the vehicle 150. In at least some embodiments, the first attachment arrangement 104a, the second attachment arrangement 104b, or both include a bracket fastener 120, such as a bolt, screw, or the like to attach the bracket 118 to the floor 152 (or other portion) of the vehicle 150. In at least some embodiments, the first attachment arrangement 104a, the second attachment arrangement 104b, or both can be attached to a floor track 156 or a seat bolt 158 located on the floor 152 of the vehicle 150 and used for attachment and movement of a vehicle seat. In at least some embodiments, the first attachment arrangement 104a, the second attachment arrangement 104b, or both are attached to the floor track 156 using an existing seat bolt 158 or track bolt of the vehicle 150. Any other suitable hardware or methods can be used to attach the first and second attachment arrangements 104a, 104b to the floor 152 of the vehicle 150 and to the rail 102. In at least some embodiments, the first end 108a and second end 108b are coupled to the floor 152 of the vehicle 154 on opposite sides of the center console 159 (FIG. 4) of the vehicle, which separates the two seating areas of the vehicle. In at least some embodiments, the first end 108a is coupled to the vehicle using a floor track 156 (or using a track bolt) associated with one seat of the vehicle and the second end 108b is coupled to the vehicle using a floor track 156 (or using a track bolt) associated with a different seat of the vehicle. In at least some embodiments, the first end 108a is coupled to the vehicle using the seat bolt 158 of one seat of the vehicle and the second end 108b is coupled to the vehicle using the seat bolt 158 of a different seat of the vehicle.

In at least some embodiments, the first attachment arrangement 104a and the second attachment arrangement 104b are attached to the corresponding first end 108a or second end 108b using an attachment fastener 122, such one or more of a bolt, bolt/nut, screw, pin, clip, clamp, adhesive, or any other suitable fastener or any combination thereof. In at least some embodiments the first attachment arrangement 104a, the second attachment arrangement 104b, or both include an end attachment piece 124 extending from the bracket 118. The end attachment post 124 is arranged to fit inside (or over) the corresponding first end 108a or second end 108a for coupling the first attachment arrangement 104a and the second attachment arrangement 104b to the corresponding first end 108 a or second end 108 b. In at least some embodiments, the first end 108a, second end 108b, and the end attachment post 124 of each of the first attachment arrangement 104a and the second attachment arrangement 104b include holes 126 for receiving the fastener 122 therethrough.

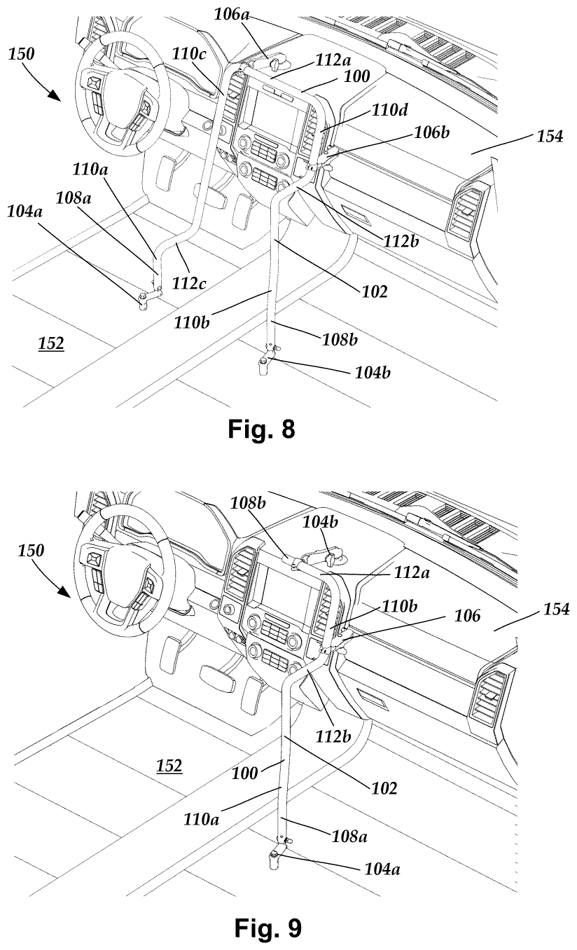

Returning to FIGS. 1 to 4, in at least some embodiments, at least one intermediate attachment arrangement 106 couples the horizontal section 112a of the rail 102 to the dashboard 154 of the vehicle 150. It will be understood that at least one intermediate attachment arrangement 106 can be used to attach any other suitable section of the rail 102 to the dashboard 154, console, engine cover, or any other part of the vehicle instead of, or in addition to, the horizontal section 112a (see, for example, FIGS. 8, 11, and 13-15).

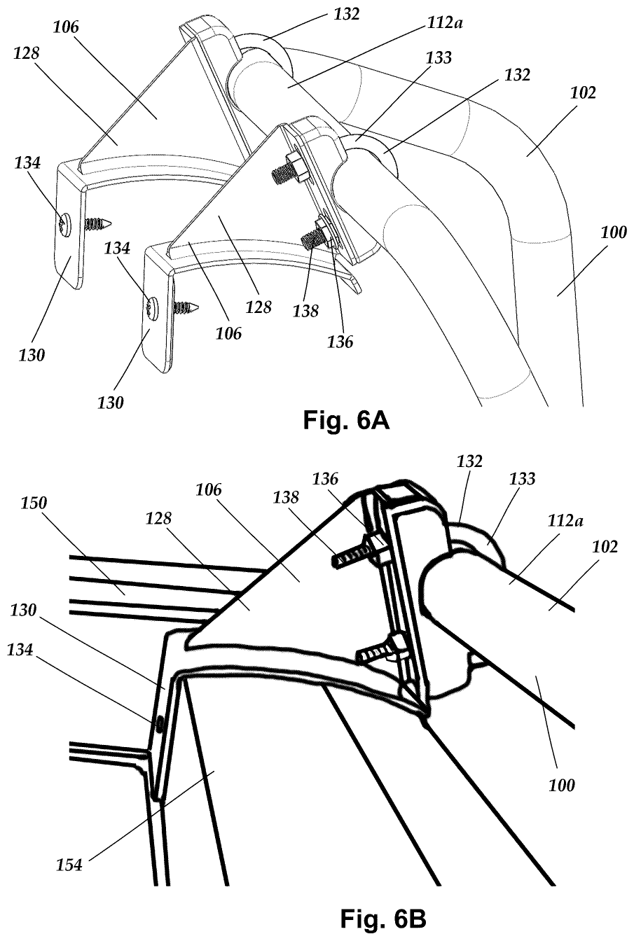

FIGS. 6A and 6B illustrate one embodiment of one or two intermediate attachment arrangements 106 attached to the rail 102. Each of the attachment arrangements 106 includes a body 128, a vehicle attachment bracket 130, and a rail attachment member 132. In at least some embodiments, the vehicle attachment bracket 130 is attached to the dashboard 154 or other part of the vehicle using a fastener 134, such as a screw, bolt, adhesive, or the like or any combination thereof, as illustrated in FIG. 6B. In at least some embodiments, the vehicle attachment bracket 130 is part of the body 128, as illustrated in FIG. 6A. In other embodiments, the vehicle attachment bracket 130 is attached to the body 128 using any suitable attachment method or hardware.

In at least some embodiments, the rail attachment member 132 extends around at least a portion of the rail 102 and is coupled to the body 128 of the intermediate attachment arrangement 106. In the illustrated embodiment of FIGS. 6A and 6B, the attachment member 132 includes a U-shaped shank 133 that is coupled to the body 128 using nuts 136 screwed onto threaded ends 138 of the U-shaped shank. Any other suitable hardware can be used for the rail attachment member 132 including, but not limited to, clamps, clips, adhesive, bolts, screws, other fasteners, brackets, or the like or any combination thereof. In the illustrated embodiments of FIGS. 6A and 6B, there are two intermediate attachment arrangements 106 but it will be understood that any number of intermediate attachment arrangements can be used including, but not limited to, one, two, three, four, five, six, seven, eight, nine, ten, twelve, or more intermediate attachment arrangements.

The first attachment arrangement 104a, second attachment arrangement 104 b, and intermediate attachment arrangements 106 of FIGS. 5A to 6B are examples. It will be understood that any other suitable attachment arrangements or methods can be used to attach the rail 102 to the vehicle 150.

One or more mounts 140 can be attached to the rail 102. At least one mount 140 can be part of the mounting system 100. At least one mount 140 can be a separate component that is subsequently used with the mounting system. There can be any combination of these two types of mounts.

In at least some embodiments, at least one mount 140 (or even all of the mounts) are removably attachable to the rail 102 of the mounting system. In at least some embodiments, at least one mount 140 is permanently attached to the rail 102 of the mounting system. There can be any combination of mounts 140 removably attachable to the rail 102 and mounts permanently attached to the rail.

In at least some embodiments, at least one mount 140 is permanently attached to the device or object 180 that is to be mounted on the mounting system 100. In at least some embodiments, at least one mount 140 is removably attachable to the device or object 180 that is to be mounted on the mounting system 100. Any combination of these two types of mounts can be used.

Non-limiting examples of mounts 140 include mounting brackets, C-clamps, clip clamps, spring clamps, hose clamps, ratcheting clamps, tube clamps, ball mounts, mounting arms, bolts, screws, adhesive, or the like or any combination thereof. Non-limiting examples of mounts can be found at U.S. Pat. Nos. 5,845,885; 6,561,476; 7,320,50; 7,997,554; 8,454,178; 8,505,861; 9,831,904; RE 42,060; RE 42,581; and RE 43,806, all of which are incorporated herein by reference in their entireties.

In at least some embodiments, one or more of the mounts 140 are arranged for at least one of (or all of) rotating, swiveling, pivoting, or tilting the device or object 180 relative to the rail 102, as illustrated, for example, by comparing device 180a and keyboard 180b in FIGS. 2 and 3. In at least some embodiments, one or more of the rotating, swiveling, pivoting, or tilting is independent of some or all of the other ones of these actions.

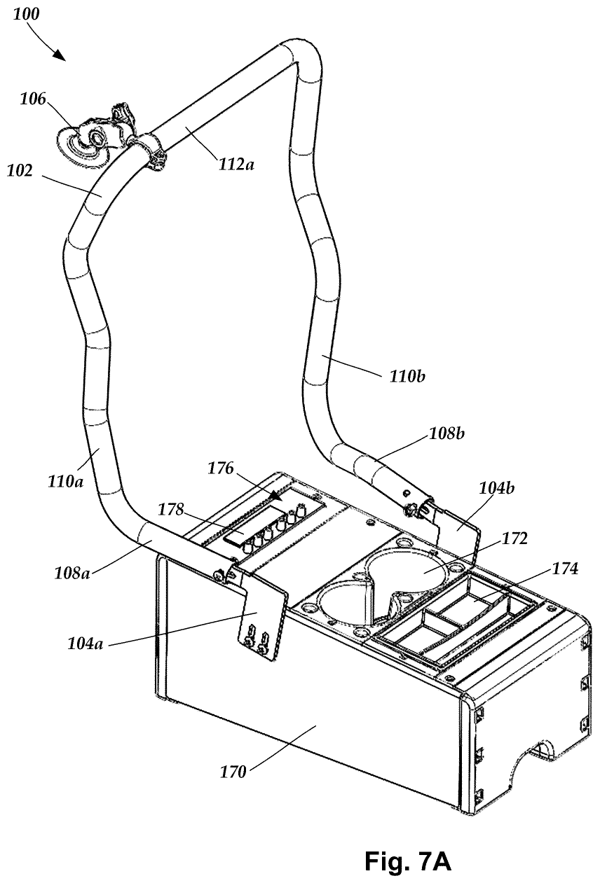

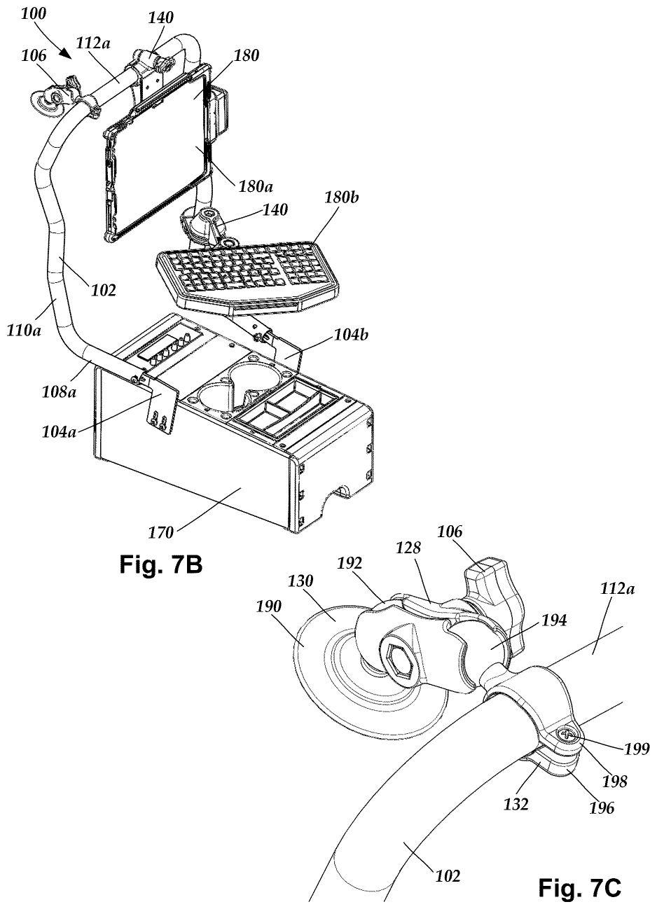

FIGS. 7A and 7B illustrate another embodiment of the mounting system 100 for mounting devices (e.g., mobile devices) or other objects 180 within a vehicle 150. The mounting system of FIGS. 7A and 7B includes a rail 102, a first attachment arrangement 104a, a second attachment arrangement 104b, and at least one intermediate attachment arrangement 106. In at least some embodiments, the mounting system does not include the at least one intermediate attachment arrangement 106. The rail 102 illustrated in FIGS. 7A and 7B includes the first and second ends 108a, 108b, the first and second sections 110a, 110b, and the horizontal section 112a and can include any of the other features described hereinabove.

In the embodiment of FIGS. 7A and 7B, the first attachment arrangement 104a couples or otherwise attaches the first end 108a of the rail 102 to a console 170 and the second attachment arrangement 104b couples or otherwise attaches the second end 108b of the rail to the console. The console 170 can be a console built into the vehicle 150 or can be a supplemental or removable console that can be mounted in the vehicle post-production. In at least some embodiments, a supplemental or removable console 170 can replace the original vehicle console or can fit over, around, or adjacent the original vehicle console or a portion thereof. In at least some embodiments, the console 170 is part of the mounting system 100. In other embodiments, the console 170 is separate from the mounting system 100.

In at least some embodiments, the console can include one or more cup holders 172, one or more trays 174, one or more slots 176 for components 178 (e.g., a radio, communication device, light switches, or the like or any combination thereof), one or more additional mounting sites (e.g., for mobile devices, etc.), or the like or any combination thereof. In at least some embodiments, the first and second attachment arrangements 104a, 104b are detachable from the console 170. In other embodiments, the first and second attachment arrangements 104a, 104b are permanently attached to the console 170.

In at least some embodiments, the first attachment arrangement 104a, the second attachment arrangement 104b, or both include at least one bracket 118 for attachment to the console 170. In at least some embodiments, the first attachment arrangement 104a, the second attachment arrangement 104b, or both include a bracket fastener 120, such as a bolt, screw, or the like to attach the bracket 118 to the console 170.

FIG. 7C illustrate is a close-up view of one embodiment of the intermediate attachment arrangement 106 attached to the rail 102. As described above with respect to the intermediate attachment arrangements 106 of FIGS. 6A and 6B, the attachment arrangement 106 of FIG. 7C includes a body 128, a vehicle attachment bracket 130, and a rail attachment member 132. The vehicle attachment bracket 130 can be attached to the dashboard or other part of the vehicle using any suitable mechanism or arrangement, such as, for example, a screw, bolt, adhesive (e.g., pressure sensitive adhesive, epoxy, any other suitable adhesive, or the like), a clamp, a suction cup, or a magnetic arrangement (e.g., a magnetic base and opposing magnetic attachment element that are disposed on opposite sides of the object upon which the bracket is mounted), or the like or any combination. (It will be understood that the first and second attachment arrangements 104a, 104b may also use any of these mechanisms or arrangements.) In this embodiment, the rail attachment member 132 extends around at least a portion of the rail 102 and is coupled to the body 128 of the intermediate attachment arrangement 106.

In the embodiments of FIG. 7C, the vehicle attachment bracket 130 includes a base 190 and a mount 192 (e.g., a ball mount) attached to the base. The body 128 is coupled or coupleable to the mount 192 and to a mount 194 of the rail attachment member 132. The mount 194 (e.g., a ball mount) of the rail attachment member 132 is attached to a clamp 196 (or any other suitable arrangement for grasping or otherwise attaching to the rail 102). The ends 198 of the clamp 196 opposite the mount 194 are optionally coupled together by a fastener 199, such as a bolt, screw, or the like. As an example of an attachment arrangement, at least a portion of the attachment arrangement of FIG. 7C (and at least some attachment arrangements illustrated in FIGS. 8-15) is the same as, or similar to, the mounting devices presented in U.S. Pat. No. 5,845,885, incorporated herein by reference in its entirety, including the split arm assembly and couplers with spherical heads described therein.

It will be understood that the first and second attachment arrangements 104a, 104b of any of the mounting systems 100 described herein can be the same or different. Any combination of attachment of the first and second attachment arrangements 104a, 104b to the floor 152 (e.g., directly to the floor (e.g., to a floorboard) or to a floor track 156 or a seat bolt 158) or a console 170 can be used. For example, one of the first and second attachment arrangements 104a, 104b can be attached, or attachable, to the floor 152, floor track 156, or seat bolt 158 and the other of the first and second attachment arrangements 104a, 104b can be attached, or attachable, to a console 170. As another example, one of the first and second attachment arrangements 104a, 104b can be attached, or attachable, to the floor 152 or a floor track 156 and the other of the first and second attachment arrangements 104a, 104b can be attached, or attachable, to a seat bolt 158.

FIG. 8 illustrates another embodiment of the mounting system 100 for mounting devices (e.g., mobile devices) or other objects 180 (see, FIG. 3) within a vehicle 150. The mounting system of FIG. 8 includes a rail 102, a first attachment arrangement 104a, a second attachment arrangement 104b, and two intermediate attachment arrangements 106a, 106b. In the embodiment of FIG. 8, the first attachment arrangement 104a couples or otherwise attaches a first end 108a of the rail 102 to a floor 152 (e.g., a floorboard) of the vehicle 150 and the second attachment arrangement 104b couples or otherwise attaches a second end 108b of the rail to the floor (e.g., a floorboard) of the vehicle. The rail 102 includes at least two vertical sections (e.g., vertical sections 110a, 110b, 110c, 110d) and at least one horizontal section (e.g., horizontal sections 112a, 112b, 112c).

The first intermediate attachment arrangement 106a couples the horizontal section 112a of the rail 102 to the dashboard 154 of the vehicle 150. As described above at least one intermediate attachment arrangement 106 can be used to attach any other suitable section of the rail 102 to the dashboard 154 and, in this embodiments, the second intermediate attachment arrangement 106b couples a vertical section 110d of the rail 102 to the dashboard 154 of the vehicle 150.

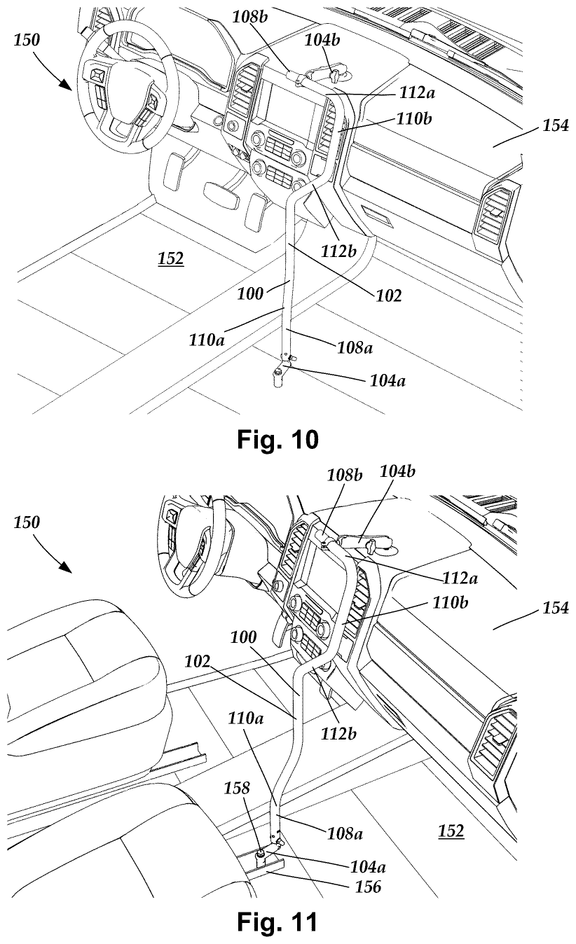

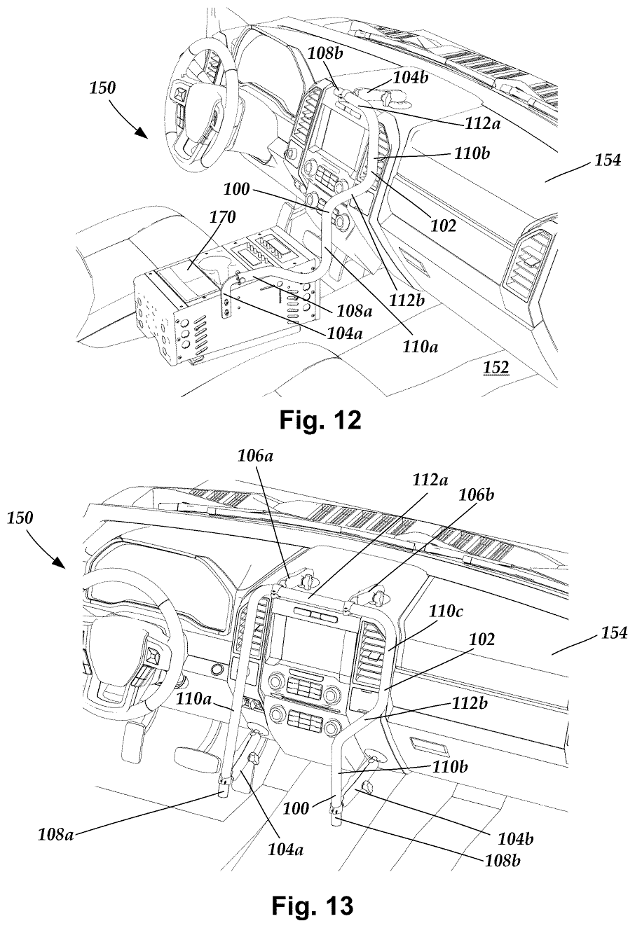

In some embodiments, one or more of the attachment arrangements can be configured for coupling to the dashboard of a vehicle, as illustrated in FIGS. 9 to 15. In at least some embodiments, one attachment arrangement can be attached, or attachable, to the dashboard 154 of the vehicle and another attachment arrangement can be attached or attachable, to the floor 152 (e.g., the embodiments illustrated in FIGS. 9 and 10), floor track 156 or seat bolt 158 (e.g., the embodiment illustrated in FIG. 11), dashboard 154 (e.g., the embodiments illustrated in FIGS. 13-15), or a console 170 (e.g., the embodiment illustrated in FIG. 12). The rail 102 and attachment arrangements illustrated in FIGS. 8-15 can also include any of the features described hereinabove. An attachment arrangement coupled to the dashboard can be coupled to a horizontal section, vertical section, or any other suitable section of the rail. In at least some embodiments, one attachment arrangement is coupled to a horizontal section of the rail, as illustrated in FIGS. 9-15. In at least some embodiments, one attachment arrangement is coupled to a vertical section of the rail, as illustrated in FIGS. 9, 11, and 13-15. In at least some embodiments, two attachment arrangements are coupled to different vertical sections of the rail, as illustrated in FIGS. 13-15.

FIG. 9 illustrates another embodiment of the mounting system 100 for mounting devices (e.g., mobile devices) or other objects 180 (see, FIG. 3) within a vehicle 150. The mounting system of FIG. 9 includes a rail 102, a first attachment arrangement 104a, a second attachment arrangement 104b, and an intermediate attachment arrangement 106. In the embodiment of FIG. 9, the first attachment arrangement 104a couples or otherwise attaches the first end 108a of the rail 102 to a floor 152 (e.g., a floorboard) of the vehicle 150. The rail 102 includes at least one or two vertical sections (e.g., vertical sections 110a, 110b) and at least one or two horizontal sections (e.g., horizontal sections 112a, 112b). The second attachment arrangement 104b couples the horizontal section 112a of the rail 102 (and the second end 108b of the rail) to the dashboard 154 of the vehicle 150. The intermediate attachment arrangement 106 can be used to attach any other suitable section of the rail 102 to the dashboard 154 and, in this embodiments, the intermediate attachment arrangement 106 couples the vertical section 110b of the rail 102 to the dashboard 154 of the vehicle 150.

FIG. 10 illustrates another embodiment of the mounting system 100 for mounting devices (e.g., mobile devices) or other objects 180 (see, FIG. 3) within a vehicle 150. The mounting system of FIG. 10 includes a rail 102, a first attachment arrangement 104a, and a second attachment arrangement 104b. In the embodiment of FIG. 10, the first attachment arrangement 104a couples or otherwise attaches the first end 108a of the rail 102 to a floor 152 (e.g., a floorboard) of the vehicle 150. The rail 102 includes at least one or two vertical sections (e.g., vertical sections 110a, 110b) and at least one or two horizontal sections (e.g., horizontal sections 112a, 112b). The second attachment arrangement 104b couples the horizontal section 112a of the rail 102 (and the second end 108b of the rail) to the dashboard 154 of the vehicle 150.

FIG. 11 illustrates another embodiment of the mounting system 100 for mounting devices (e.g., mobile devices) or other objects 180 (see, FIG. 3) within a vehicle 150. The mounting system of FIG. 11 includes a rail 102, a first attachment arrangement 104a, and a second attachment arrangement 104b. In the embodiment of FIG. 11, the first attachment arrangement 104a couples or otherwise attaches the first end 108a of the rail 102 to a floor track 156 or a seat bolt 158 of the vehicle 150. The rail 102 includes at least one or two vertical sections (e.g., vertical sections 110a, 110b) and at least one or two horizontal sections (e.g., horizontal sections 112a, 112b). The second attachment arrangement 104b couples the horizontal section 112a of the rail 102 (and the second end 108b of the rail) to the dashboard 154 of the vehicle 150.

FIG. 12 illustrates another embodiment of the mounting system 100 for mounting devices (e.g., mobile devices) or other objects 180 (see, FIG. 3) within a vehicle 150. The mounting system of FIG. 11 includes a rail 102, a first attachment arrangement 104a, and a second attachment arrangement 104b. In the embodiment of FIG. 12, the first attachment arrangement 104a couples or otherwise attaches the first end 108a of the rail 102 to a console 170. The rail 102 includes at least one or two vertical sections (e.g., vertical sections 110a, 110b) and at least one or two horizontal sections (e.g., horizontal sections 112a, 112b). The second attachment arrangement 104b couples the horizontal section 112a of the rail 102 (and the second end 108b of the rail) to the dashboard 154 of the vehicle 150.

FIG. 13 illustrates another embodiment of the mounting system 100 for mounting devices (e.g., mobile devices) or other objects 180 (see, FIG. 3) within a vehicle 150. The mounting system of FIG. 11 includes a rail 102, a first attachment arrangement 104a, a second attachment arrangement 104b, and two intermediate attachment arrangements 106a, 106b. The rail 102 includes at least one or two vertical sections (e.g., vertical sections 110a, 110b, 110c) and at least one or two horizontal sections (e.g., horizontal sections 112a, 112b). In the embodiment of FIG. 13, the first attachment arrangement 104a couples or otherwise attaches a first end 108a of the rail 102 (and vertical section 110a) to a dashboard 154 of the vehicle 150 and the second attachment arrangement 104b couples or otherwise attaches a second end 108b of the rail 102 (and vertical section 110b) to the dashboard of the vehicle. The two intermediate attachment arrangements 106a, 106b couple the horizontal section 112a of the rail 102 to the dashboard 154 of the vehicle 150.

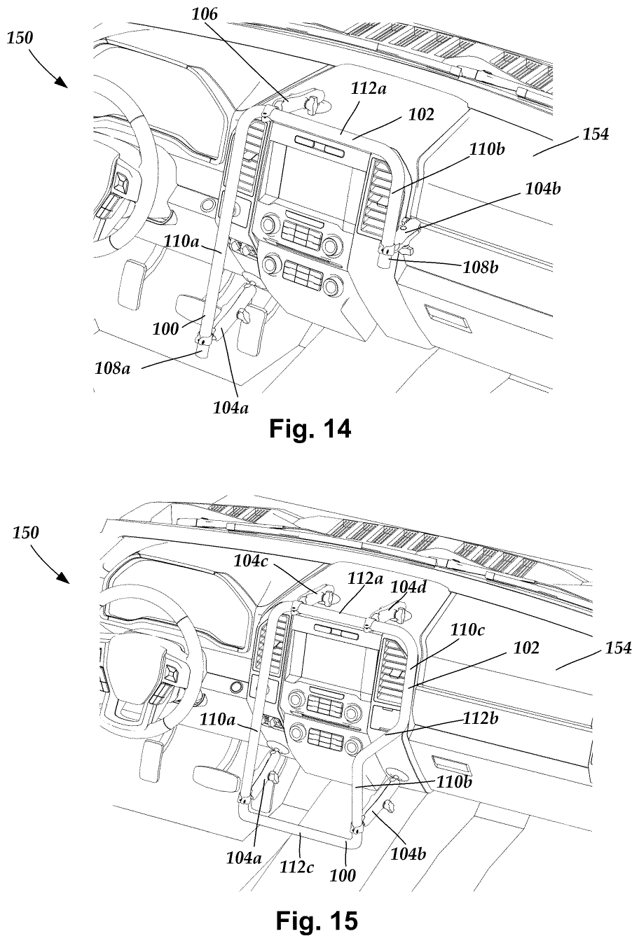

FIG. 14 illustrates another embodiment of the mounting system 100 for mounting devices (e.g., mobile devices) or other objects 180 (see, FIG. 3) within a vehicle 150. The mounting system of FIG. 11 includes a rail 102, a first attachment arrangement 104a, a second attachment arrangement 104b, and one intermediate attachment arrangement 106. The rail 102 includes at least one or two vertical sections (e.g., vertical sections 110a, 110b) and at least one or two horizontal sections (e.g., horizontal section 112a). In the embodiment of FIG. 14, the first attachment arrangement 104a couples or otherwise attaches a first end 108a of the rail 102 (and vertical section 110a) to a dashboard 154 of the vehicle 150 and the second attachment arrangement 104b couples or otherwise attaches a second end 108b of the rail 102 (and vertical sections 110b) to the dashboard of the vehicle. The intermediate attachment arrangement 106 couples the horizontal section 112a of the rail 102 to the dashboard 154 of the vehicle 150.

FIG. 15 illustrates another embodiment of the mounting system 100 for mounting devices (e.g., mobile devices) or other objects 180 (see, FIG. 3) within a vehicle 150. The mounting system of FIG. 11 includes a rail 102 and four attachment arrangements 104a, 104b, 104c, 104d. The rail 102 forms a loop and includes at least two vertical sections (e.g., vertical sections 110a, 110b, 110c) and at least two horizontal sections (e.g., horizontal sections 112a, 112b, 112c). In the embodiment of FIG. 15, the first attachment arrangement 104a couples or otherwise attaches the first vertical section 110a of the rail 102 to a dashboard 154 of the vehicle 150 and the second attachment arrangement 104b couples or otherwise attaches the second vertical section 110b of the rail 102 to the dashboard of the vehicle. The third and fourth attachment arrangements 104c, 104d couple the horizontal section 112a of the rail 102 to the dashboard 154 of the vehicle 150.

For embodiments that include a rail 102 that forms a loop, the mounting system 100 includes at least two, three, or four attachment arrangements (e.g., attachment arrangements 104a, 104b, 104c, 104d of FIG. 15.) In at least some embodiments, at least two of the attachment arrangements are coupled or otherwise attached to different vertical sections of the rail 102 and to the dashboard 154 (or console 170) of the vehicle 150. In at least some embodiments, at least one of the attachment arrangements is coupled or otherwise attached to at least one horizontal section of the rail 102 and to the dashboard 154 of the vehicle 150.

In at least some embodiments, a mounting system 100 may include multiple, different attachment arrangements with each attachment arrangement configured for attachment to one or more of a floor 152 (e.g., a floorboard or any other portion of the floor of the vehicle), a floor track 156, a seat bolt 158, a dashboard 154, or a console 170. Having multiple, different attachment arrangements 104a, 104b gives a user or installer the ability to select from the different attachment arrangements based on what component (e.g., floor 152, a floor track 156, a seat bolt 158, a dashboard 154, or a console 170) the attachment arrangement will be attached to. For example, to permit a user to select from different attachment arrangements, a kit for a mounting system 100 might be provided with any combination of attachment arrangements for mounting to the floor 152, attachment arrangements for mounting to a floor track 156, attachment arrangements for mounting to a seat bolt 158, attachment arrangements for mounting to a dashboard 154, or attachment arrangements for mounting to a console 170. For the kit might include two of each of the listed attachment arrangements so that the user can select which combination of attachment arrangements is desired for installation of the mounting system 100 in the vehicle 150. In some embodiments, a particular attachment arrangement may be capable of mounting onto two or more of a floor 152, a floor track 156, a seat bolt 158, a dashboard 154, or a console 170. In at least some embodiments, the first or second attachment arrangement 104a, 104b is configured for attachment to two or more (or all) of a floor 152, a floor track 156, a seat bolt 158, a dashboard 154, or a console 170. In at least some embodiments, the first or second attachment arrangement 104a, 104b is configured for attachment to one or more (but not all) of a floor 152, a floor track 156, a seat bolt 158, a dashboard 154, or a console 170.

The above specification provides a description of the manufacture and use of the invention. Since many embodiments of the invention can be made without departing from the spirit and scope of the invention, the invention also resides in the claims hereinafter appended.

What is claimed as new and desired to be protected by Letters Patent of the United States is:

1. A mounting system for mounting devices or objects within a vehicle, the mounting system comprising:
a rail having a first end configured for coupling to a console attached to, or mountable in, the vehicle and a second end, opposite the first end, configured for coupling to a floor of the vehicle or the console, the rail comprising a first section extending upward from the first end away from the console when the rail is coupled to the console, a second section extending upward from the second end away from the floor or the console when the rail is coupled to the floor or the console, and a horizontal section intermediate between the first section to the second section and having a horizontal length of at least 0.07 meters, wherein the rail is configured for attachment of one or more mounts to the rail at multiple positions along the rail;
a first attachment arrangement configured for attachment to the first end of the rail and for attachment to the floor or the console; and
a second attachment arrangement physically separate from the first attachment arrangement and configured for attachment to the second end of the rail and for attachment to the floor or the console.

2. The mounting system of claim 1, wherein the second end is configured for coupling to the console and the second attachment arrangement is configured for attachment to the console.

3. The mounting system of claim 1, further comprising a first intermediate attachment arrangement configured for coupling the horizontal section of the rail to a dashboard, another console, or an engine cover of the vehicle.

4. The mounting system of claim 3, further comprising a second intermediate attachment arrangement configured for coupling the rail to the dashboard, the other console, or the engine cover of the vehicle.

5. The mounting system of claim 1, further comprising the console, wherein the console is mountable in the vehicle.

6. The mounting system of claim 1, further comprising a mount attached or attachable to the rail.

7. The mounting system of claim 6, wherein the mount is configured for coupling to a device or object.

8. The mounting system of claim 7, wherein the mount is configured for at least one of rotating, tilting, pivoting, or swiveling the coupled device or object.

9. A method for using the mounting system of claim 1, the method comprising:
providing the mounting system in the vehicle; and
attaching a mount to the rail of the mounting system.

10. A mounting system for mounting devices or objects within a vehicle, the mounting system comprising:
a rail having a first end configured for coupling to a floor of a vehicle and a second end opposite the first end, the rail comprising a first section extending upward from the first end away from the floor when the rail is coupled to the floor and a horizontal section intermediate between the first section and the second end, the horizontal section having a horizontal length of at least 0.07 meters, wherein the rail is configured for attachment of one or more mounts to the rail at multiple positions along the rail;
a first attachment arrangement configured for attachment to the first end of the rail and for attachment to the floor; and
a second attachment arrangement physically separate from the first attachment arrangement and configured for attachment of the horizontal section to a dashboard of the vehicle.

11. The mounting system of claim 10, further comprising a third attachment arrangement configured for attachment to the second end of the rail and for attachment to the floor.

12. The mounting system of claim 11, further comprising a fourth attachment arrangement configured for attachment to the rail and for attachment to the dashboard.

13. The mounting system of claim 10, wherein the first attachment arrangement is configured for coupling to the floor of the vehicle via a floor track using a fastener of the floor track.

14. The mounting system of claim 10, wherein the first attachment arrangement is configured for coupling to the floor of the vehicle via a seat bolt.

15. A mounting system for mounting devices or objects within a vehicle, the mounting system comprising:
a rail having at least one vertical section extending vertically relative to the vehicle when the mounting system is mounted in the vehicle and at least one horizontal section extending horizontally relative to the vehicle when the mounting system is mounted in the vehicle, the at least one horizontal section comprising a first horizontal section having a horizontal length of at least 0.07 meters, wherein the rail is configured for attachment of one or more mounts to the rail at multiple positions along the rail;
a first attachment arrangement configured for attachment to a one of the at least one vertical section and for attachment to a dashboard of the vehicle or a console attached to, or mountable in, the vehicle; and
a second attachment arrangement physically separate from the first attachment arrangement and configured for attachment to the first horizontal section and for attachment to the dashboard of the vehicle.

16. The mounting system of claim 15, wherein the first attachment arrangement is configured for attachment to the console.

17. The mounting system of claim 16, further comprising a third attachment arrangement configured for attachment to the rail and for attachment to the dashboard.

18. The mounting system of claim 17, wherein the at least one vertical section comprises a first vertical section and a second vertical section that is separated from the first vertical section by at least one of the at least one horizontal section, wherein the first attachment arrangement is configured for attachment to the first vertical section and the third attachment arrangement is configured for attachment to the third vertical section.

19. The mounting system of claim 15, wherein the rail forms a loop.

20. The mounting system of claim 15, wherein the horizontal section has a horizontal length of at least 0.1 meters.
